(19) United States
(12) Patent Application Publication
(10) Pub. No.: US 2026/0080147 A1
(43) Pub. Date: Mar. 19, 2026

(54) TEXT STYLE TRANSFER ON TRANSLATED CONTENT USING NEURAL NETWORKS

(71) Applicant: Adobe Inc., San Jose, CA (US)

(72) Inventors: Deergh Singh Budhauria, Ghaziabad (IN); Rishav Agarwal, Howrah (IN); Sanyam Jain, New Delhi (IN); Tracy Holloway King, Mountain View, CA (US)

(21) Appl. No.: 18/890,155

(22) Filed: Sep. 19, 2024

(51) Int. Cl. G06F 40/103; G06F 40/58

(52) U.S. Cl. CPC G06F 40/103; G06F 40/58

(57) ABSTRACT

The present disclosure relates to systems, non-transitory computer-readable media, and methods for transferring style formatting on translated text using neural networks. In particular, in some embodiments, the disclosed systems obtain an input text string, the input text string comprising a style formatting element. In addition, in some embodiments, the disclosed systems generate a modified input text string from the input text string, the modified input text string comprising a coded tag identifying the style formatting element. Moreover, in some embodiments, the disclosed systems generate, utilizing a neural machine translation model, a translated text string from the modified input text string. Furthermore, in some embodiments, the disclosed systems apply the style formatting element to a word of the translated text string based on the coded tag of the modified input text string.

### BACKGROUND

Recent years have seen developments in hardware and software platforms implementing translation models for translating text from one language to another. For example, existing translation systems, such as neural machine translation and large language models, are able to generate translated text and in some cases are even able to apply stylizations (e.g., highlights, italics, underlines, etc.) in an effort to carry over stylizations originally applied to the initial text content. Despite these developments, existing systems suffer from a number of technical deficiencies, including inaccuracy in generating stylized translated text.

### BRIEF SUMMARY

Embodiments of the present disclosure provide benefits and/or solve one or more problems in the art with systems, non-transitory computer-readable media, and methods for generating stylized translated text content using machine learning models. For instance, in some embodiments, the disclosed systems determine a stylization applied to a text string in a given language. From the stylized text string, in some implementations, the disclosed systems generate a translated text string in a different language using a transformer neural network. Additionally, in some embodiments, the disclosed systems determine attention head values generated by the transformer neural network that indicate relationships between words in the initial text and words in the translated text. Thus, in some embodiments, the disclosed systems utilize the attention heads to determine which translated words of the translated text string to stylize.

Moreover, in some implementations, the disclosed systems utilize an alternative technique for style transfer on translated text without determining attention head values. For example, in some embodiments, the disclosed systems utilize a neural machine translation model and/or a large language model to translate text and apply stylizations from an input text on the translated text. For example, in some implementations, the disclosed systems modify an input text with coded tags or delimiters to delineate the beginning and end of style formatting in the input text. Moreover, in some embodiments, the disclosed systems process the modified text (e.g., the text including the tags/delimiters) through the neural machine translation model or the large language model to generate a translated text that retains the coded tags or delimiters. Furthermore, in some embodiments, the disclosed systems apply the style formatting elements to the translated text based on (e.g., between) the coded tags or delimiters.

In some implementations, the disclosed systems utilize a hybrid model that employs the neural machine translation model to translate an input text and the large language model to determine translated words of the translated text to stylize. For example, in some embodiments, the disclosed systems use unigram mappings of stylized words of the input text to identify the translated words of the translated text for stylization. Moreover, in some implementations, the disclosed systems apply a style of the stylized input words to the translated words to generate a stylized translated text.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a style preservation system operates in accordance with one or more embodiments.

FIG. 2 illustrates an overview of the style preservation system generating a stylized translated text string from an input text string in accordance with one or more embodiments.

FIG. 3 illustrates the style preservation system generating an attention head matrix in accordance with one or more embodiments.

FIGS. 4A-4B illustrate the style preservation system extracting a style from an input text string and utilizing attention heads to apply the style to a translated text string in accordance with one or more embodiments.

FIGS. 5A-5B illustrate the style preservation system providing a stylized input text string and a stylized translated text string for display via a graphical user interface in accordance with one or more embodiments.

FIG. 6 illustrates an overview of alternative text style preservation techniques in accordance with one or more embodiments.

FIG. 7 illustrates the style preservation system using a neural machine translation model to generate translated text with coded tags for styling the translated text in accordance with one or more embodiments.

FIG. 8 illustrates the style preservation system using a large language model to generate translated text with delimiters for styling the translated text in accordance with one or more embodiments.

FIG. 9 illustrates the style preservation system using a neural machine translation model to generate translated text from an input text and a large language model to determine translated words for stylization in accordance with one or more embodiments.

FIGS. 10A-10B illustrate the style preservation system providing an input graphic with stylized text and a translated graphic with stylized translated text for display via a graphical user interface in accordance with one or more embodiments.

FIG. 11 illustrates a diagram of an example architecture of the style preservation system in accordance with one or more embodiments.

FIG. 12 illustrates a flowchart of a series of acts for preserving styles of translated text using attention head values in accordance with one or more embodiments.

FIG. 13 illustrates a flowchart of a series of acts for preserving styles of translated text using neural networks in accordance with one or more embodiments.

FIG. 14 illustrates a block diagram of an example computing device for implementing one or more embodiments of the present disclosure.

### DETAILED DESCRIPTION

This disclosure describes one or more embodiments of a style preservation system that generates stylized translated text content using machine learning models. For instance, in some embodiments, the style preservation system obtains an input text string in a first language and extracts a style formatting element indicating or defining a style applied to the input text string. Moreover, in some implementations, the style preservation system generates a translated text string in a second language different from the first language using a transformer neural network. Additionally, in some embodiments, the style preservation system determines attention head values generated by the transformer neural network during the translation process. In some embodiments, the style preservation system further generates an attention head matrix from the attention head values, where the matrix defines relationships between words in the initial text and words in the translated text. Accordingly, in some embodiments, the style preservation system utilizes the attention head matrix to determine which translated words of the translated text string to stylize. In some implementations, the style preservation system generates a stylized translated text string by applying the style formatting element to the translated words.

Moreover, in some implementations, the style preservation system utilizes an alternative technique for style transfer on translated text without generating an attention head matrix. For example, in some embodiments, the style preservation system utilizes a neural machine translation model and/or a large language model to translate text and apply stylizations from an input text on the translated text. For example, in some implementations, the style preservation system modifies an input text with coded tags or delimiters to identify style formatting elements in the input text. Moreover, in some embodiments, the style preservation system processes the modified text through the neural machine translation model or the large language model to generate a translated text that retains the coded tags or delimiters. Furthermore, in some embodiments, the style preservation system applies the style formatting elements to the translated text based on the coded tags or delimiters.

In some implementations, the style preservation system utilizes a hybrid model that employs the neural machine translation model to translate an input text and that employs the large language model to determine translated words of the translated text to stylize. For example, in some embodiments, the style preservation system uses unigram mappings of stylized words of the input text to identify the translated words of the translated text for stylization. Moreover, in some implementations, the style preservation system applies a style of the stylized input words to the translated words to generate a stylized translated text.

In some implementations, the style preservation system facilitates creation of designs in multiple languages (such as a version in English, a version in Spanish, etc.). For example, design content creators often choose to extend a graphic design from an original language to one or more other languages. For instance, a target audience of a design may include linguistic variation across a country, across a region, or even world-wide. More particularly, globalization of graphic designs (e.g., used in marketing, magazines, etc.) is increasingly important for communication to broad audiences. To accomplish this, textual content in graphic designs needs to be accurately translated and have text styling preserved in order to fit visually into the design. Preserving text styling often requires high accuracy word alignment between the original text and the translated text.

The style preservation system offers multilingual capabilities to convert a design from one language to another language. Moreover, in some implementations, the style preservation system generates translated content with preserved stylization in multiple languages beyond the initial language. For instance, the style preservation system obtains a graphic that includes English text. The style preservation system then generates translated graphics (e.g., in German, French, Italian, etc.) that preserve the graphical and stylistic elements of the original graphic. For example, the corresponding German, French, and Italian texts in the translated graphics have styles that match the styles of the original English text.

Although existing systems generate translated text for an input text string, such systems have a number of problems in relation to accuracy of style formatting for the translated text. For instance, some existing systems apply text styles to translated text content that does not reflect the stylization of input text content. For example, in some cases, existing systems apply stylization to wrong portions of a translated text. In some instances, existing systems apply stylization to the wrong words, particularly where different portions of the would-be stylized words should be separated or divided by un-stylized words in the translated text.

Beyond inaccurate stylization, certain existing systems generate machine translations in plain text without any style formatting at all. In these instances, a user is left to manually apply stylizations after the machine translation is performed. Thus, due to the inaccuracy of such systems, these systems are also inefficient, often requiring excessive operations (e.g., inputs, selections, clicks, etc.) to accomplish stylization of translated text.

Due at least in part to their inaccuracy and their inefficient stylizing, existing systems often waste computational resources. For example, while some existing transformer neural networks generate attention head values while performing machine translation, the attention head values are not utilized beyond the internal processes of the machine translation. For instance, some existing systems use extensive computations to generate the attention head values, yet these existing systems ignore the attention head values for other computational tasks, such as determining stylized words of an input text string.

The style preservation system provides a variety of technical advantages relative to existing systems. For example, by using attention heads of a transformer neural network to determine which translated words of a translated text string are correlated with stylized input words of the input text string, the style preservation system improves accuracy relative to existing systems. For instance, by using an attention head matrix, the style preservation system generates stylized translated text that accurately reflects the stylization of the input text string. In addition, by using a neural machine translation model to generate translated text and by using a large language model to determine which translated words to stylize, the style preservation system accurately translates text and accurately determines stylizations for the translated text that match the stylizations for the input text.

In particular, using an attention head matrix, a neural machine translation model, and/or a large language model, the style preservation system stylizes the translated text string to match the stylization of the input text string, even when the translated text string has a different number of words than the input text string and/or a different order of words than the input text string. In some implementations, the style preservation system accurately stylizes the translated text string according to the stylization of the input text string, including text strings with multiple types of stylizations in multiple places (e.g., multiple stylized words with different styles in different parts of a sentence). Moreover, in some embodiments, the style preservation system accurately stylizes translated text strings that have different numbers of words than the corresponding input text strings (e.g., a translated German sentence with a compound word that corresponds to multiple input words of an input English sentence). Furthermore, in some implementations, the style preservation system accurately stylizes translated text strings even when the translated text has a different tokenization strategy than the input text (e.g., when translating from a language with word spacing, such as English, to a language without word spacing, such as Chinese).

Moreover, the style preservation system offers a user interface with reduced need for user inputs relative to existing systems, such as reduced need for user interaction with multiple different subsystems. For instance, in some embodiments, the style preservation system performs both machine translation and stylization based on a single input of a stylized input text string. As another example in some embodiments, the style preservation system integrates a neural machine translation model and a large language model to generate stylized translated text that operates on a stylized input text without requiring a user to interface with multiple computing applications. Thus, compared to prior systems that only generate un-stylized translations, the style preservation system reduces the interactions required to stylize translated text (e.g., to zero interactions on translated text).

Furthermore, in some embodiments, the style preservation system increases computing efficiency by utilizing attention head values from a transformer neural network for additional functionality beyond machine translation. For example, the style preservation system utilizes the attention head values to determine translated words of a translated text string that correlate with stylized words of an input text string, thereby making better use of the computing resources required to generate the attention head values. Accordingly, compared to prior systems that ignore attention head values for computational tasks outside of machine translation, the style preservation system efficiently utilizes computational resources by gleaning relational information for the input text string and the translated text string from the attention head matrix. More particularly, the style preservation system uses the attention head values generated by the transformer neural network to determine this relational information, thereby avoiding a need to redetermine relational information in other ways that would otherwise require further computations.

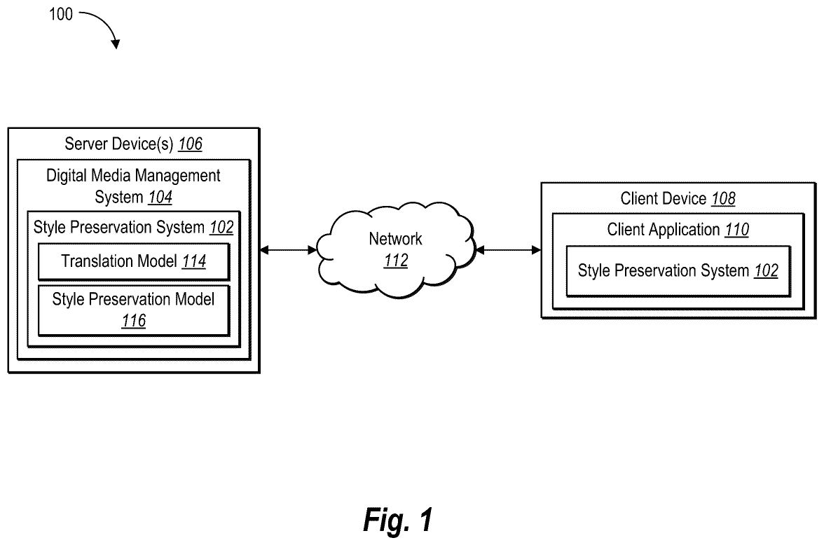

Additional detail will now be provided in relation to illustrative figures portraying example embodiments and implementations of a style preservation system. For example, FIG. 1 illustrates a system 100 (or environment) in which a style preservation system 102 operates in accordance with one or more embodiments. As illustrated, the system 100 includes server device(s) 106, a network 112, and a client device 108. As further illustrated, the server device(s) 106 and the client device 108 communicate with one another via the network 112.

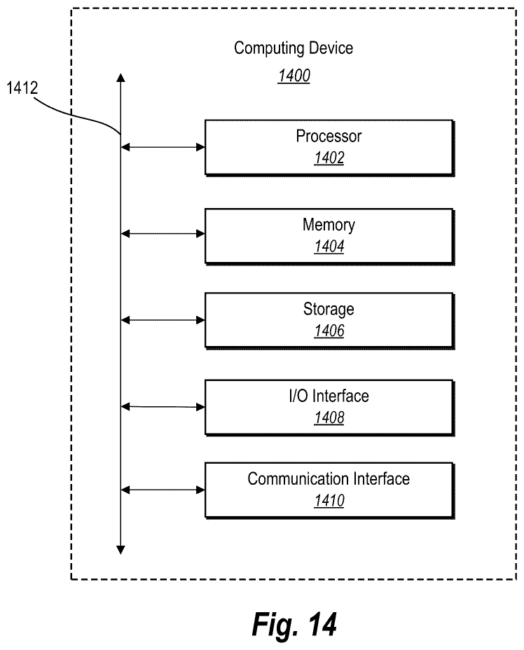

As shown in FIG. 1, the server device(s) 106 includes a digital media management system 104 that further includes the style preservation system 102. In some embodiments, the style preservation system 102 utilizes one or more machine learning models (e.g., a translation model 114 and/or a style preservation model 116) to translate text and/or preserve style formatting for the text. For example, in some implementations, the style preservation system 102 utilizes the machine learning models to generate a translated text string from an input text string, and to apply a style formatting element to one or more translated words of the translated text string. In some embodiments, the server device(s) 106 includes, but is not limited to, a computing device (such as explained below with reference to FIG. 14).

A machine learning model includes a computer representation that is tunable (e.g., trained) based on inputs to approximate unknown functions used for generating corresponding outputs. In particular, in one or more embodiments, a machine learning model is a computer-implemented model that utilizes algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof.

Similarly, a neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer neural network, or a generative adversarial neural network.

A transformer neural network includes a neural network that utilizes attention mechanisms to generate embeddings for sequential data. In particular, a transformer neural network includes a self-attention mechanism (e.g., attention heads) to generate representations (or embeddings) that account for long range dependencies and contextual information between different portions of data in sequential data (e.g., via tokens).

A neural machine translation model includes one or more neural networks comprising multiple layers of interconnected nodes to process input texts and generate translations of the input text. In some embodiments, a neural machine translation model includes an encoder-decoder architecture that converts an input text into a dense, high-dimensional context vector, and then converts the context vector into translated text in a target language. In some implementations, a neural machine translation model includes a transformer neural network that utilizes an attention mechanism to focus on multiple parts of an input text when generating each word of the translated text. Moreover, in some embodiments, a neural machine translation model includes a general purpose neural network for machine translation. In some embodiments, a neural machine translation model includes a special purpose neural network tailored to a particular machine translation application (e.g., for a particular language, a particular format of source text, etc.).

In some instances, the style preservation system 102 receives a request (e.g., from the client device 108) to translate an input text and transfer style from the input text to the translated text. For example, the style preservation system 102 obtains the input text and receives a request to translate the input text and preserve stylization of the input text. Some embodiments of server device(s) 106 perform a variety of functions via the digital media management system 104 on the server device(s) 106. To illustrate, the server device(s) 106 (through the style preservation system 102 on the digital media management system 104) performs functions such as, but not limited to, extracting a style formatting element from an input text string, generating a translated text string from the input text string, generating an attention head matrix for words of the input text string, and generating a stylized translated text string. In some embodiments, the server device(s) 106 utilizes the translation model 114 and/or the style preservation model 116 to generate stylized translated text strings. In some embodiments, the server device(s) 106 trains the translation model 114 and/or the style preservation model 116.

Furthermore, as shown in FIG. 1, the system 100 includes the client device 108. In some embodiments, the client device 108 includes, but is not limited to, a mobile device (e.g., a smartphone, a tablet), a laptop computer, a desktop computer, or any other type of computing device, including those explained below with reference to FIG. 14. Some embodiments of client device 108 perform a variety of functions via a client application 110 on client device 108. For example, the client device 108 (through the client application 110) performs functions such as, but not limited to, extracting a style formatting element from an input text string, generating a translated text string from the input text string, generating an attention head matrix for words of the input text string, and generating a stylized translated text string. In some embodiments, the client device 108 utilizes the translation model 114 and/or the style preservation model 116 to generate stylized translated text strings. In some embodiments, the client device 108 trains the translation model 114 and/or the style preservation model 116.

To access the functionalities of the style preservation system 102 (as described above and in greater detail below), in one or more embodiments, a user interacts with the client application 110 on the client device 108. For example, the client application 110 includes one or more software applications (e.g., to transfer styles from input text to translated text in accordance with one or more embodiments described herein) installed on the client device 108, such as a digital media management application, a text editing application, and/or a graphic design application. In certain instances, the client application 110 is hosted on the server device(s) 106. Additionally, when hosted on the server device(s) 106, the client application 110 is accessed by the client device 108 through a web browser and/or another online interfacing platform and/or tool. Furthermore, in some embodiments, the client device 108, the server device(s) 106, or another system host one or more databases including digital data.

As illustrated in FIG. 1, in some embodiments, the style preservation system 102 is hosted by the client application 110 on the client device 108 (e.g., additionally, or alternatively to being hosted by the digital media management system 104 on the server device(s) 106). For example, the style preservation system 102 performs the text style preservation techniques described herein on the client device 108. In some implementations, the style preservation system 102 utilizes the server device(s) 106 to train and implement machine learning models (such as the translation model 114 and/or the style preservation model 116). In one or more embodiments, the style preservation system 102 utilizes the server device(s) 106 to train machine learning models (such as the translation model 114 and/or the style preservation model 116) and utilizes the client device 108 to implement or apply the machine learning models.

Further, although FIG. 1 illustrates the style preservation system 102 being implemented by a particular component and/or device within the system 100 (e.g., the server device(s) 106 and/or the client device 108), in some embodiments the style preservation system 102 is implemented, in whole or in part, by other computing devices and/or components in the system 100. For instance, in some embodiments, the style preservation system 102 is implemented on another client device. More specifically, in one or more embodiments, the description of (and acts performed by) the style preservation system 102 is/are implemented by (or performed by) the client application 110 on another client device.

In some embodiments, the client application 110 includes a web hosting application that allows the client device 108 to interact with content and services hosted on the server device(s) 106. To illustrate, in one or more implementations, the client device 108 accesses a web page or computing application supported by the server device(s) 106. The client device 108 provides input to the server device(s) 106 (e.g., a request to translate text and preserve stylization). In response, the style preservation system 102 on the server device(s) 106 performs operations described herein to generate stylized translated text. The server device(s) 106 provides the output or results of the operations (e.g., stylized translated text strings, graphic designs with stylized translated text, etc.) to the client device 108. As another example, in some implementations, the style preservation system 102 on the client device 108 performs operations described herein to generate stylized translated text. The client device 108 provides the output or results of the operations (e.g., stylized translated text strings, graphic designs with stylized translated text, etc.) via a display of the client device 108, and/or transmits the output or results of the operations to another device (e.g., the server device(s) 106 and/or another client device).

Additionally, as shown in FIG. 1, the system 100 includes the network 112. As mentioned above, in some instances, the network 112 enables communication between components of the system 100. In certain embodiments, the network 112 includes a suitable network and communicates using any communication platforms and technologies suitable for transporting data and/or communication signals, examples of which are described with reference to FIG. 14. Furthermore, although FIG. 1 illustrates the server device(s) 106 and the client device 108 communicating via the network 112, in certain embodiments, the various components of the system 100 communicate and/or interact via other methods (e.g., the server device(s) 106 and the client device 108 communicate directly).

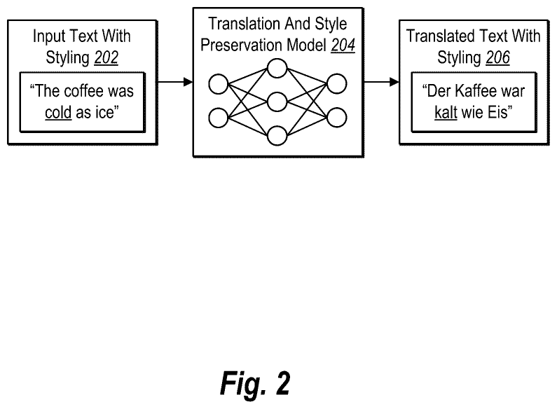

As discussed above, in some embodiments, the style preservation system 102 preserves style formatting for translated text. For instance, FIG. 2 illustrates an example overview of the style preservation system 102 generating a stylized translated text string from an input text string in accordance with one or more embodiments. Additional detail regarding the various acts introduced in relation to FIG. 2 is provided thereafter with reference to subsequent figures.

Specifically, FIG. 2 shows the style preservation system 102 obtaining an input text string 202 in a first language. The input text string 202 includes a style formatting element. A style formatting element includes a data construct or computer code segment defining a stylization for one or more characters (e.g., one or more words) of a text string, such as font style, font size, color, underline, italic, bold, highlight, hyperlinks, outline, capitalization, strikethrough, orientation, shape, subscript, and superscript. Moreover, in some embodiments, a style formatting element includes stylization for a paragraph, such as indentation, spacing, tabbing, bullets and numbering, justification, and alignment. Furthermore, in some implementations, a style formatting element includes stylization for a section or page, such as margins, orientation, breaks, columns, headers, and footers. In the example shown in FIG. 2, the input text string 202 reads “The coffee was cold as ice” with a style formatting element of underline on the word “cold.”

Moreover, FIG. 2 shows the style preservation system 102 processing the input text string 202 through a translation and style preservation model 204 to generate a stylized translated text 206. For example, the style preservation system 102 utilizes the translation and style preservation model 204 to generate a translated text string in a second language different from the first language, and to apply a translated style formatting element to the translated text string. A translated style formatting element includes a style formatting element for a translated text string, for example, to preserve a formatting of the input text for the translated text. In the example shown in FIG. 2, the stylized translated text 206 reads (in German) “Der Kaffee war kalt wie Eis” with a translated style formatting element of underline on the word “kalt.” Depending on the embodiment, the translation and style preservation model 204 takes the form of a variety of different types of machine learning models, such as a transformer neural network, a neural machine translation model, a large language model, and/or a combination of one or more of the above.

As mentioned, in some embodiments, the style preservation system 102 utilizes the translation and style preservation model 204 to translate and/or stylize the input text string 202. To illustrate, in some implementations, the style preservation system 102 utilizes a machine learning model, such as a transformer neural network, to perform machine translation to generate translated text strings in one or more languages different from the first language. Moreover, in some embodiments, the style preservation system 102 utilizes a neural machine translation model to generate translated text strings in one or more languages different from the first language. Furthermore, in some embodiments, the style preservation system 102 utilizes a large language model to generate translated text strings in one or more languages different from the first language.

Relatedly, in some embodiments, the style preservation system 102 utilizes a machine learning model to generate a stylization (e.g., a translated style formatting element) and apply the stylization to a translated text string (e.g., to match the style formatting element applied to the input text string 202). Moreover, in some implementations, the style preservation system 102 utilizes a hybrid approach to apply a neural machine translation model to generate a translated text string from an input text string, and to apply a large language model to determine and apply stylization for the translated text string.

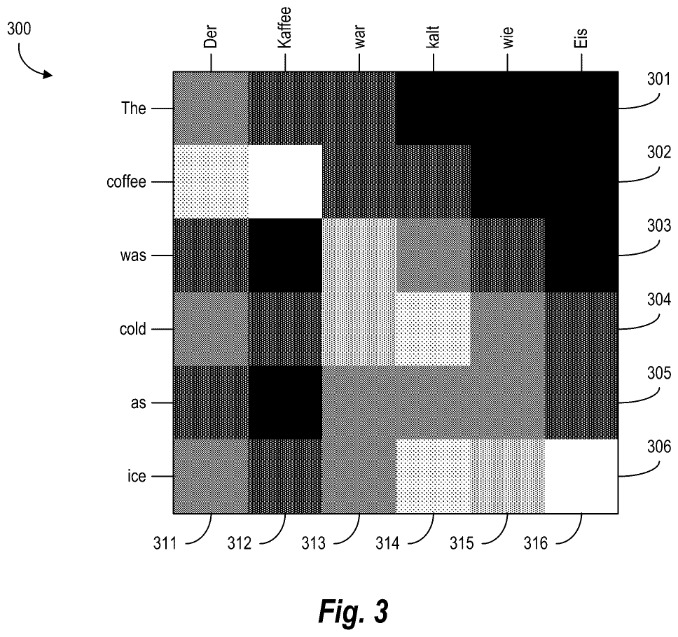

As mentioned, in some embodiments, the style preservation system 102 determines attention head values for words of a text string. For instance, FIG. 3 illustrates the style preservation system 102 generating an attention head matrix in accordance with one or more embodiments.

Specifically, FIG. 3 shows the style preservation system 102 generating an attention head matrix 300 from attention head values of a transformer neural network. In particular, the attention head matrix 300 includes rows 301-306 associated with words of an input text string (e.g., “The coffee was cold as ice”). Additionally, the attention head matrix 300 includes columns 311-316 associated with words of a translated text string (e.g., “Der Kaffee war kalt wie Eis”). For example, each word of the input text string is assigned a row of the attention head matrix 300, where the row has cells that include attention head values for the word of the input text string in relation to each word of the translated text string.

In some embodiments, the style preservation system 102 determines the attention head values from a transformer neural network. For instance, the style preservation system 102 utilizes the transformer neural network to generate the translated text string from the input text string. While generating the translated text string, the transformer neural network generates attention head values. An attention head value includes a metric or measure of focus placed on a part of the input text string by the transformer neural network.

As mentioned, in some implementations, an attention head value indicates a relationship between a word of the input text string and a translated word of the translated text string. For instance, a relatively large attention head value indicates a close relationship (e.g., a high correlation) between the input word and the translated word. By contrast, a relatively small attention head value (e.g., near zero or zero) indicates a distant relationship (e.g., a low correlation) between the input word and the translated word. In the example shown in FIG. 3, the attention head matrix 300 has light shades, including white, to indicate larger attention head values representing higher correlations between words. Similarly, the attention head matrix 300 has dark shades, including black, to indicate smaller attention head values representing lower correlations between words.

As illustrated in FIG. 3 for the example input text string and translated text string, the input word “coffee” has a high correlation with the translated word “Kaffee” (indicated by the cell on row 302 and column 312) and a low correlation with the translated word “Eis” (indicated by the cell on row 302 and column 316). As another example, the input word “ice” has a high correlation with the translated word “Eis” (indicated by the cell on row 306 and column 316), a medium correlation with the translated word “kalt” (indicated by the cell on row 306 and column 314), and a low correlation with the word “Kaffee” (indicated by the cell on row 306 and column 312). As described in further detail below, in some embodiments, the style preservation system 102 utilizes the attention head values to determine stylizations for translated text strings by determining correlations between stylized words of input text strings and translated words of the translated text strings.

Moreover, while the example attention head matrix of FIG. 3 is a square matrix, in some embodiments, the style preservation system 102 generates an attention head matrix that is not square. For example, in some cases, the input text string has more words than the translated text string, in which case the style preservation system 102 generates an attention head matrix that has more rows than columns. Conversely, in some cases, the input text string has fewer words than the translated text string, in which case the style preservation system 102 generates an attention head matrix that has more columns than rows. The style preservation system 102 accordingly determines correlations between input words and translated words where one input word is mapped to many translated words and/or where many input words are mapped to one translated word. Indeed, in some cases, the style preservation system 102 determines a threshold attention head value to ascribe correlation (e.g., a threshold relationship strength) between words. The style preservation system 102 thus determines a correlation between words (e.g., one-to-one, one-to-many, or many-to-one) for attention head values that satisfy the threshold.

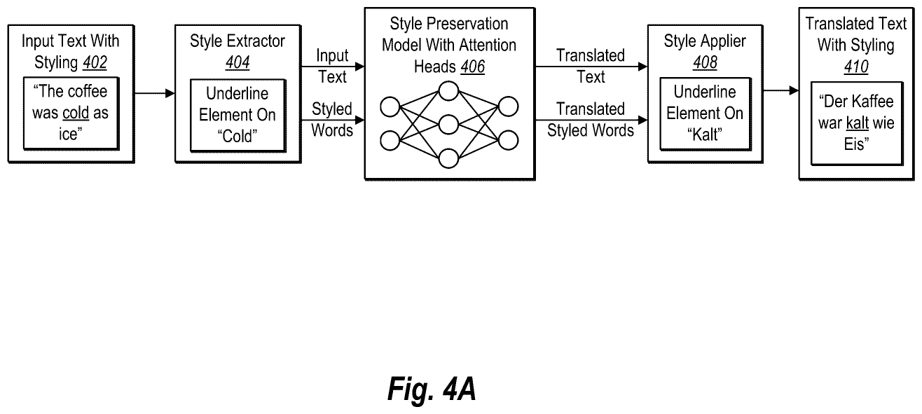

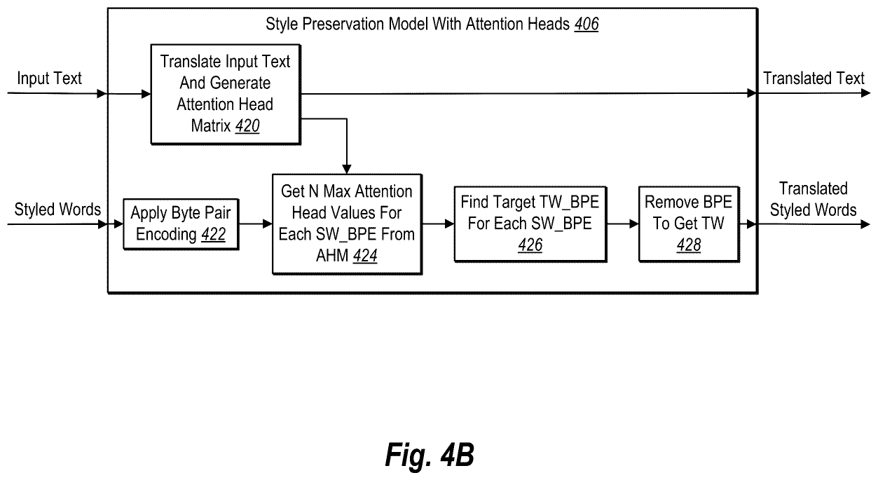

As discussed above, in some embodiments, the style preservation system 102 utilizes attention heads to preserve styles of an input text string for a translated text string. For instance, FIGS. 4A-4B illustrate the style preservation system 102 extracting a style from an input text string and utilizing attention heads to apply the style to a translated text string in accordance with one or more embodiments.

Specifically, FIG. 4A shows the style preservation system 102 obtaining an input text string 402 and processing the input text string 402 through a style extractor 404. For example, the style preservation system 102 determines a style formatting element in the input text string 402. Moreover, in some implementations, the style preservation system 102 extracts the style formatting element from the input text string 402 using the style extractor 404. In the example shown in FIG. 4A, the style preservation system 102 utilizes the style extractor 404 to extract an underline style formatting element from the word “cold” in the input text string 402. In some embodiments, a style extractor includes a neural network that identifies style formatting of text and interprets the style formatting as a numerical representation. For example, a style extractor includes an encoder that converts a style formatting element to a vector representation for the stylization of the style formatting element. In some embodiments, a style extractor includes computer code, such as a routine or a function, that reads style information directly from text formatting (e.g., html formatting, font coding, etc.) to determine a style formatting element.

In some embodiments, the style preservation system 102 processes the input text string and the style formatting element through a style preservation model 406. In some implementations, the style preservation model 406 is a transformer neural network that uses attention heads. As shown in FIG. 4A, the style preservation system 102 processes the input text string and styled words (e.g., input words containing the style formatting element) through the style preservation model 406. As described in additional detail below in connection with FIG. 4B, in some implementations, the style preservation system 102 utilizes the style preservation model 406 to generate translated text and translated styled words. For instance, the style preservation system 102 uses the transformer neural network to generate the translated text string from the input text string 402.

Additionally, in some implementations, the style preservation system 102 uses the transformer neural network to determine attention head values for the words of the input text string 402 relative to the words of the translated text string. Furthermore, and as discussed in additional detail below, the style preservation system 102 uses the attention head values to map the styled words of the input text string 402 to translated words of the translated text string. From these translated words, the style preservation system 102 generates styled translated words using the style formatting element(s) corresponding to the styled words of the input text string 402.

Moreover, in some embodiments, the style preservation system 102 uses a style applier 408 to generate a stylized translated text string 410. For instance, the style preservation system 102 generates the stylized translated text string 410 by applying the style formatting element to the translated text string using the style applier 408. In the example shown in FIG. 4A, the style preservation system 102 utilizes the style applier 408 to apply the underline style formatting element on the word “kalt” in the translated text string to generate the stylized translated text string 410. In some embodiments, a style applier includes a neural network that interprets numerical representations of stylization to add the stylization to text. For example, a style applier includes a decoder that converts a vector representation for stylization to a style formatting element and adds the style formatting element to a translated text. In some embodiments, a style applier includes computer code, such as a routine or a function, that copies style information (e.g., html codes, rule-based formatting, etc.) in a style formatting element onto a text string. Moreover, in some embodiments, a style applier is a separate model from a machine translation model. For example, in some embodiments, the style preservation system 102 uses a machine translation model (such as a neural machine translation model or a large language model) to translate text, and uses a style extractor and a style applier to stylize the text.

As mentioned, FIG. 4B shows additional detail of the style preservation model 406. In particular, in some implementations, the style preservation system 102 uses the style preservation model 406 to translate the input text string to generate the translated text string. Additionally, in some implementations, the style preservation system 102 uses the style preservation model 406 to generate the styled translated words for the styled translated text string from the styled words of the input text string.

To illustrate, in some embodiments, the style preservation system 102 performs an act 420 to translate the input text string 402 and generate an attention head matrix (e.g., attention head matrix 300). For example, the style preservation system 102 uses a transformer neural network to generate the translated text string. For instance, the style preservation system 102 utilizes an encoder to determine intermediate representations for words of the input text string 402 and compares the intermediate representations with each other to determine correlations between words.

In some implementations, the style preservation system 102 uses a transformer neural network that has layers of encoders and decoders. For instance, the encoders take each word of the input text string, process the word into an intermediate representation, and compare the intermediate representation with the other intermediate representations of the other words of the input text string. The results of these comparisons are attention scores that indicate a contribution of each word in the input text string to a key word. The style preservation system 102 uses the attention scores as weights for word representations that are fed to a fully connected network that generates a new representation for the key word. The style preservation system 102 performs this process for each word in the input text string and transfers the new representation along with attention values to the decoders, which use the new representations and attention values to generate predictions. Moreover, each encoder generates a weighted sum of the previous encoder states. The style preservation system 102 processes the weighted sum through the decoders to produce a final machine translation along with the attention head matrix.

Furthermore, the decoders have access to hidden states of the encoders used to predict the translated words. The style preservation system 102 weighs different hidden states differently as not all hidden states are relevant in every step. The style preservation system 102 uses the transformer neural network to focus on the relevant parts in the input text string. In each iteration, the style preservation system 102 uses the decoder to receive input from the encoder and the previous output of the decoder for use in the next step.

Moreover, in some embodiments, the style preservation system 102 retains positional information about each word of the input text string by generating an index of word location based on sine and cosine functions. The style preservation system 102 adds this information to the embedding vector as a positional encoding and processes the positional encoding through the encoders.

As mentioned, in some embodiments, the style preservation system 102 generates the attention head matrix with attention head values for the words of the input text string 402. For example, the style preservation system 102 determines the attention head values generated by the transformer neural network for the words of the input text string 402 as part of generating the translated text string in the second language. For instance, the style preservation system 102 maps relationships between the words of the input text string 402 and translated words of the translated text string. More particularly, the style preservation system 102 compares encoder states for the input text string 402 to predict the relationships between the words of the input text string 402 and the translated words of the translated text string.

As also shown in FIG. 4B, in some implementations, the style preservation system 102 utilizes byte pair encoding to generate the stylized translated words from the stylized words of the input text string 402. For instance, the style preservation system 102 performs an act 422 of applying a byte pair encoding to the stylized words. To illustrate, the style preservation system 102 generates a byte pair encoding for a stylized word (e.g., “cold”) of the input text string 402. Furthermore, the style preservation system 102 performs an act 424 of obtaining the n (e.g., 3, 5, or some other number) highest attention head values for the byte pair encoding for the stylized word from the attention head matrix. Moreover, in some implementations, the style preservation system 102 performs a string search in each row of the attention head matrix to find the most correlated translated words (from the columns of the attention head matrix) to each element of the byte pair encoding for each stylized word. For instance, the style preservation system 102 generates a list of translated styled words as byte pair encodings.

To further illustrate, in some embodiments, the style preservation system 102 performs an act 426 of finding a target byte pair encoding for the translated words of the translated text string for each byte pair encoding of the stylized words. For instance, the style preservation system 102 determines an embedding distance between the byte pair encoding for the stylized word and a translated byte pair encoding of a translated word of the translated text string. Moreover, in some implementations, the style preservation system 102 performs an act 428 of removing the byte pair encoding from the translated byte pair encoding to generate the translated word for stylization.

Furthermore, in some implementations, the style preservation system 102 applies a style of the stylized word to the translated word of the translated text string based on the embedding distance. For example, the style preservation system 102 utilizes the style applier 408 to add the style of the stylized word to the translated word based on the embedding distance. For instance, the style preservation system 102 compares a first attention head value for a stylized word of the input text string relative to a first translated word of the translated text string and a second attention head value for the stylized word of the input text string relative to a second translated word of the translated text string. Additionally, the style preservation system 102 uses the style applier 408 to add the style of the stylized word to the first word of the translated text string based on comparing the first attention head value and the second attention head value (e.g., based on the first translated word having a shorter embedding distance to the stylized input word than the second translated word).

As mentioned, in some embodiments, the style preservation system 102 generates a translated style formatting element for a translated text string. For instance, the style preservation system 102 utilizes the attention head values to map a translated word of the translated text string with a stylized word of the input text string by the style formatting element. Moreover, in some embodiments, the style preservation system 102 applies the style formatting element to the translated word of the translated text string. Thus, in some embodiments, the style preservation system 102 generates the stylized translated text string by applying the style formatting element to the translated text string according to the attention head matrix. Furthermore, in some embodiments, the style preservation system 102 post-processes the stylized translated text by dropping stylization from some of the stylized translated words to make the styling structure of the translated text more like that of the input text.

In addition, in some implementations, the style preservation system 102 maps an input word to more than one translated word, or vice versa. For instance, the style preservation system 102 maps a word of the input text string to a plurality of translated words of the translated text string based on corresponding attention head values exceeding a threshold attention head value. For example, as described above in connection with FIG. 3, in some cases, the attention head matrix is non square because the relationships between input words to translated words are not one-to-one. For example, if the attention head matrix has more columns than rows, there are more words in the translated text string than in the input text string. In these cases, for example, a word of the input text string correlates with multiple words of the translated text string (or a few words of the input text string correlate with more than a few words of the translated text string).

Similarly, in some examples, the style preservation system 102 maps a plurality of words of the input text string to a translated word of the translated text string based on corresponding attention head values exceeding a threshold attention head value. For example, the style preservation system 102 determines that multiple words of the input text string have a short embedding distance from the translated word, and thus all of those multiple input words correspond to the translated word. Therefore, in some embodiments, the style preservation system 102 matches the stylization of that translated word with the stylization of those multiple input words.

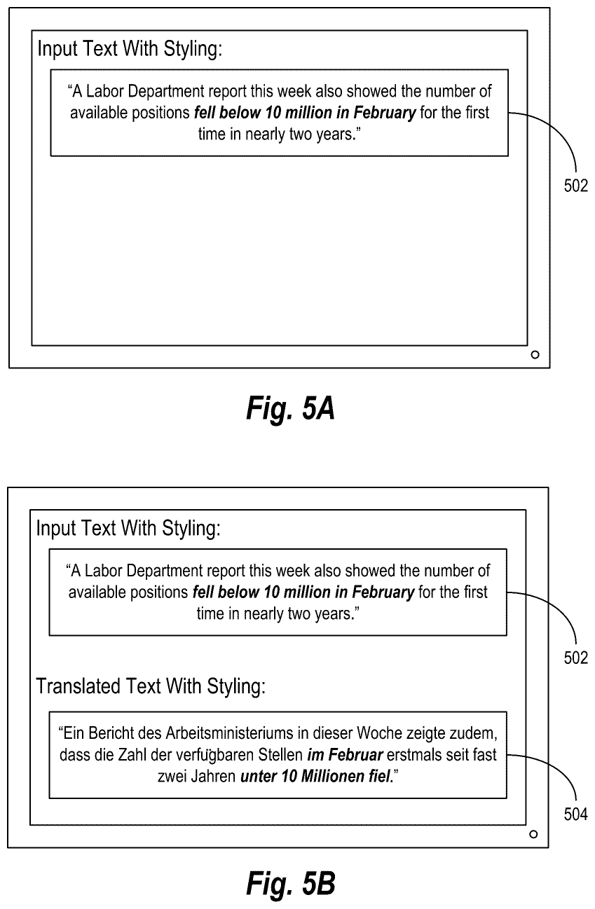

As mentioned, in some embodiments, the style preservation system 102 provides a stylized translated text string for display. For instance, FIGS. 5A-5B illustrate the style preservation system 102 providing a stylized input text string and a stylized translated text string for display via a graphical user interface in accordance with one or more embodiments.

Specifically, FIG. 5A shows a computing device (e.g., client device 108) with a graphical user interface. In some implementations, style preservation system 102 provides, for display via the graphical user interface, an input text string 502 comprising a style formatting element. In the example shown, the input text string reads “A Labor Department report this week also showed the number of available positions fell below 10 million in February for the first time in nearly two years.” Additionally, the input text string 502 has a style formatting element including bold and italic text on the words “fell below 10 million in February” while the remainder of the input text string 502 contains plain English text.

As described above, in some embodiments, the style preservation system 102 processes the input text string 502 through a translation and style preservation model to generate a stylized translated text string 504. Moreover, FIG. 5B shows the style preservation system 102 providing the stylized translated text string 504 for display via the graphical user interface. In the example shown, the stylized translated text string 504 reads “Ein Bericht des Arbeitsministeriums in dieser Woche zeigte zudem, dass die Zahl der verfügbaren Stellen im Februar erstmals seit fast zwei Jahren unter 10 Millionen fiel.” Additionally, the stylized translated text string 504 has a translated style formatting element including bold and italic text on the words “im Februar” and “unter 10 Millionen fiel” while the remainder of the stylized translated text string 504 contains plain German text.

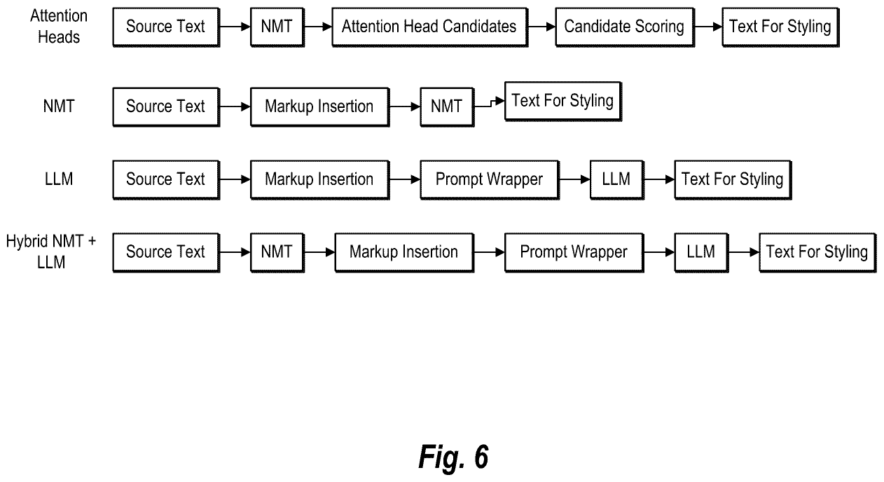

As mentioned above, in some embodiments, the style preservation system 102 uses a variety of approaches to style preservation for machine translation. For instance, FIG. 6 illustrates four alternative style preservation techniques in accordance with one or more embodiments. Moreover, in some implementations, the style preservation system 102 utilizes these style preservation techniques for graphic design translation. For example, the style preservation system 102 translates text within a graphic design to another language and applies stylizations of the original text to the translated text to preserve appearances of the original graphic design in the translated graphic designs.

Specifically, FIG. 6 shows a first style preservation technique using attention heads (e.g., as described in detail above in connection with FIGS. 3-5B), a second style preservation technique using a neural machine translation model, a third style preservation technique using a large language model, and a fourth style preservation technique using a hybrid approach with a neural machine translation model and a large language model.

As described above in detail, the style preservation system 102 employs the first style preservation technique using attention heads by processing a source text through a neural machine translation model (e.g., a transformer neural network), generating attention head candidates, scoring the attention head candidates, and determining portions of the translated text for stylization based on the scores of the attention head values. As mentioned, this technique utilizes attention head values from the transformer neural network. However, in some cases, the attention head values might not be accessible for scoring. Thus, in some embodiments, the style preservation system 102 uses an alternative style preservation technique, such as by using the neural machine translation model (NMT), the large language model (LLM), or the hybrid approach.

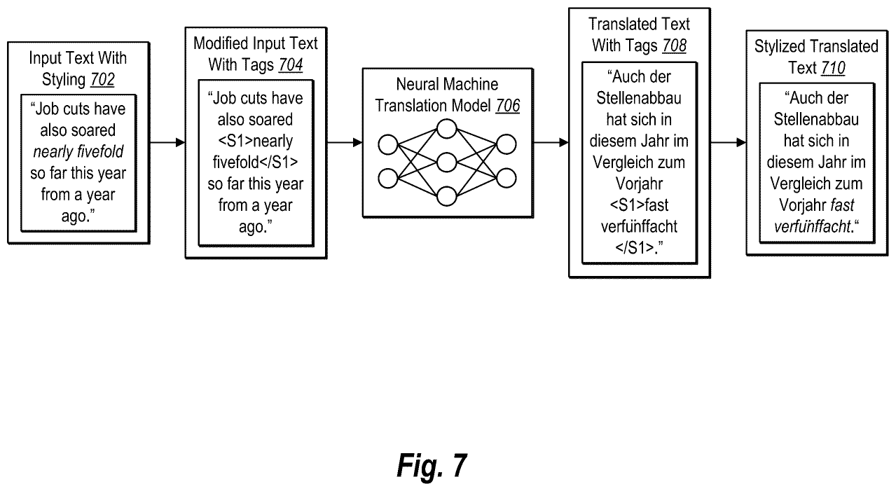

In some implementations, the style preservation system 102 uses the NMT approach to style preservation. For instance, the style preservation system 102 obtains the source text (e.g., input text string 202), applies a markup insertion to the source text, and processes the marked-up text through a neural machine translation model to generate the text for styling. Additional detail of this approach is given below in connection with FIG. 7.

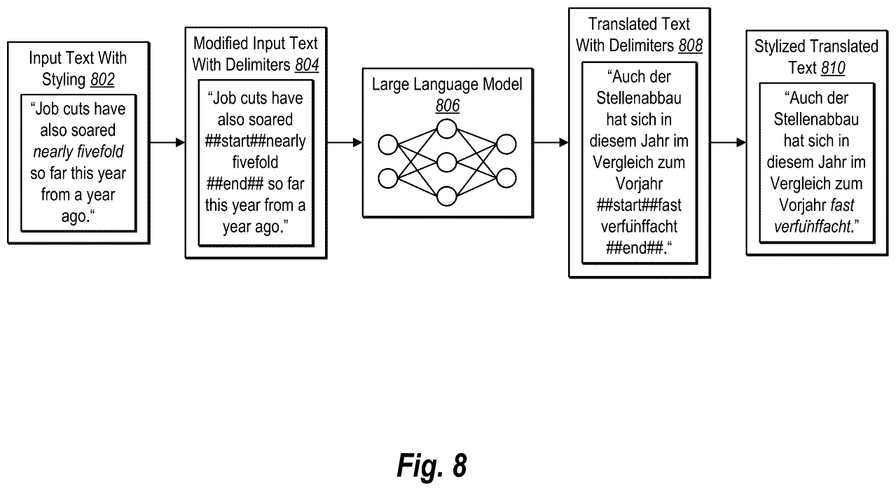

Moreover, in some implementations, the style preservation system 102 uses the LLM approach to style preservation. For example, the style preservation system 102 obtains the source text (e.g., input text string 202), applies a markup insertion to the source text, generates a prompt wrapper for a large language model, and processes the marked-up text and prompt wrapper through the large language model to generate the text for styling. Additional detail of this approach is given below in connection with FIG. 8.

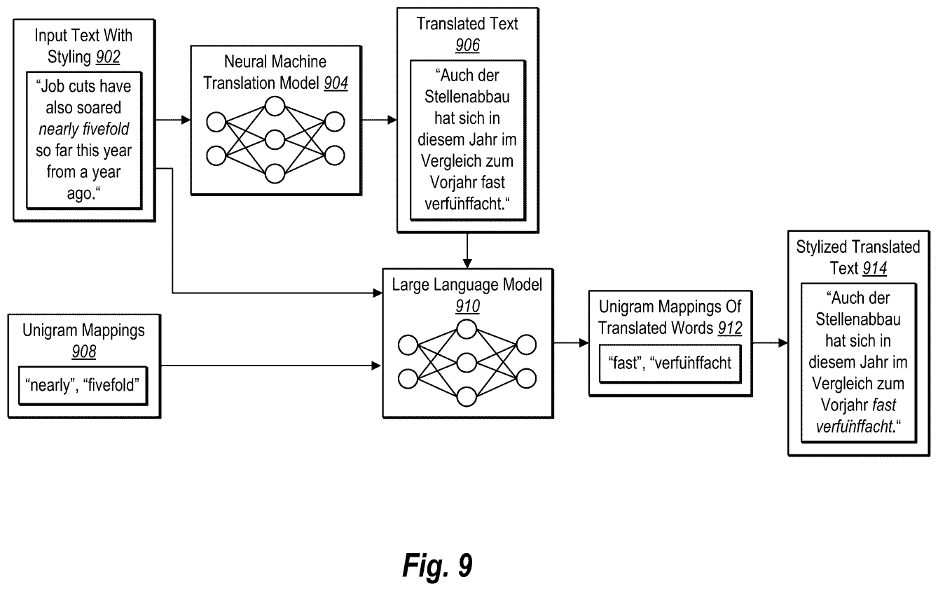

Furthermore, in some embodiments, the style preservation system 102 uses the hybrid NMT and LLM approach to style preservation. For instance, the style preservation system 102 obtains the source text (e.g., input text string 202), processes the source text through a neural machine translation model to generate a translated text, applies a markup insertion to the translated text, generates a prompt wrapper for a large language model, and processes the marked-up translated text and the prompt wrapper through the large language model to generate the text for styling. Additional detail of this approach is given below in connection with FIG. 9.

As discussed, in some cases, the style preservation system 102 preserves text styling in graphic designs with high accuracy in word alignment between the original text and the translated text. Moreover, the style preservation system 102 uses any of these four techniques (i.e., attention heads, NMT, LLM, and/or hybrid NMT+LLM) to preserve stylization of text within graphic designs.

As mentioned, in some embodiments, the style preservation system 102 uses the NMT approach to style preservation. For instance, FIG. 7 illustrates the style preservation system 102 using a neural machine translation model to generate translated text with coded tags for styling the translated text in accordance with one or more embodiments.

Specifically, FIG. 7 shows the style preservation system 102 obtaining an input text string 702. The input text string 702 has a style formatting element. In the example shown in FIG. 7, the input text string 702 reads “Job cuts have also soared nearly fivefold so far this year from a year ago,” with an italic style formatting element on the words “nearly fivefold.”

Moreover, FIG. 7 shows the style preservation system 102 generating a modified input text string 704 from the input text string 702. In particular, the style preservation system 102 generates the modified input text string 704 with a coded tag identifying the style formatting element. For example, the style preservation system 102 generates a first coded tag at a beginning of a text portion comprising the style formatting element (e.g., before the word “nearly”), and a second coded tag at an end of the text portion comprising the style formatting element (e.g., after the word “fivefold”). Moreover, in some embodiments, the style preservation system 102 generates multiple pairs of coded tags to mark multiple style formatting elements.

Furthermore, FIG. 7 shows the style preservation system 102 processing the modified input text string 704 through a neural machine translation model 706. For example, the style preservation system 102 uses the neural machine translation model 706 to generate a translated text string 708 from the modified input text string 704. For instance, the style preservation system 102 generates the translated text string 708 and retains the first coded tag and the second coded tag in the translated text string 708. In the example shown in FIG. 7, the translated text string 708 reads (in German) “Auch der Stellenabbau hat sich in diesem Jahr im Vergleich zum Vorjahr<S1>fast verfünffacht</S1>.” Thus, as illustrated, the first and second coded tags bracket the translated words “fast verfünffacht,” which correspond with the stylized words “nearly fivefold” in the input text string 702.

Moreover, FIG. 7 shows the style preservation system 102 generating a stylized translated text string 710 by applying (e.g., via the style applier 408 described above) the style formatting element to a word of the translated text string 708 based on the coded tag of the modified input text string 704. For instance, the style preservation system 102 removes the first coded tag and the second coded tag from the translated text string 708, and stylizes the translated text string by applying the style formatting element to a translated text portion corresponding to the text portion. In the example shown, the translated words “fast verfünffacht” in the stylized translated text string 710 are italicized according to the italic style formatting element from the input text string 702.

Furthermore, as mentioned, in some embodiments, the style preservation system 102 uses the LLM approach to style preservation. For instance, FIG. 8 illustrates the style preservation system 102 using a large language model to generate translated text with delimiters for styling the translated text in accordance with one or more embodiments.

Specifically, FIG. 8 shows the style preservation system 102 obtaining an input text string 802. The input text string 802 has a style formatting element. In the example shown in FIG. 8, the input text string 802 reads “Job cuts have also soared nearly fivefold so far this year from a year ago,” with an italic style formatting element on the words “nearly fivefold.”

Moreover, FIG. 8 shows the style preservation system 102 generating a modified input text string 804 from the input text string 802. In particular, the style preservation system 102 generates the modified input text string 804 with a first delimiter identifying a beginning of the style formatting element and a second delimiter identifying an end of the style formatting element. For example, the style preservation system 102 generates the first delimiter at a beginning of a text portion comprising the style formatting element (e.g., before the word “nearly”), and the second delimiter at an end of the text portion comprising the style formatting element (e.g., after the word “fivefold”).

Furthermore, FIG. 8 shows the style preservation system 102 processing the modified input text string 804 through a large language model 806. For example, the style preservation system 102 uses the large language model 806 to generate a translated text string 808 from the modified input text string 804. For instance, the style preservation system 102 generates the translated text string 808 and retains the first delimiter and the second delimiter in the translated text string 808. In the example shown in FIG. 8, the translated text string 808 reads (in German) “Auch der Stellenabbau hat sich in diesem Jahr im Vergleich zum Vorjahr ##start##fast verfünffacht##end##.” Thus, as illustrated, the first and second delimiters bracket the translated words “fast verfünffacht,” which correspond with the stylized words “nearly fivefold” in the input text string 802. Thus, in some implementations, the large language model 806 identifies the correct words in the translated text string 808 for stylization, but does not identify a style type (e.g., italics) to apply. As discussed above and in further detail below, in some implementations, the style preservation system 102 determines the style type (e.g., using a style extractor) and applies the style type (e.g., using a style applier) to the translated words for stylization.

Moreover, FIG. 8 shows the style preservation system 102 generating a stylized translated text string 810 by applying the style formatting element to a word of the translated text string 808 based on the first delimiter and the second delimiter of the modified input text string 804. For instance, the style preservation system 102 removes the first delimiter and the second delimiter from the translated text string 808, and stylizes the translated text string by applying the style formatting element to a translated text portion corresponding to the text portion. In the example shown, the translated words “fast verfünffacht” in the stylized translated text string 810 are italicized according to the italic style formatting element from the input text string 802.

As part of instructing the large language model 806, in some embodiments, the style preservation system 102 generates a prompt for the large language model 806. For example, the style preservation system 102 generates a prompt that defines the first delimiter and the second delimiter. To illustrate, the prompt explains that the first delimiter marks the beginning of a special style around the stylized text portion and that the second delimiter marks the end of the special style around the stylized text portion. Moreover, in some embodiments, the style preservation system 102 generates multiple pairs of delimiters to mark multiple style formatting elements. In addition, in some embodiments, the prompt includes instructions for the large language model 806 to translate the input text string 802 while retaining the first delimiter and the second delimiter in the translated text string 808.

Furthermore, in some embodiments, the style preservation system 102 generates the translated text string 808 by processing the prompt through the large language model 806 with the modified input text string 804. For example, the style preservation system 102 provides the modified input text string 804 to the large language model 806, and instructs the large language model (via the prompt) to translate the modified input text string 804 while preserving the delimiters.

As mentioned, in some embodiments, the style preservation system 102 uses the hybrid NMT+LLM approach to style preservation. For instance, FIG. 9 illustrates the style preservation system 102 using a neural machine translation model to generate translated text from an input text and a large language model to determine translated words for stylization in accordance with one or more embodiments.

Specifically, FIG. 9 shows the style preservation system 102 obtaining an input text string 902. The input text string 902 has a style formatting element. In the example shown in FIG. 9, the input text string 902 reads “Job cuts have also soared nearly fivefold so far this year from a year ago,” with an italic style formatting element on the words “nearly fivefold.”

Moreover, FIG. 9 shows the style preservation system 102 processing the input text string 902 through a neural machine translation model 904 to generate a translated text string 906. In the example shown in FIG. 9, the translated text string 906 reads (in German) “Auch der Stellenabbau hat sich in diesem Jahr im Vergleich zum Vorjahr fast verfünffacht.” However, at this stage, the style preservation system 102 does not retain stylization in the translated text string 906. Instead, the style preservation system 102 utilizes a large language model 910 to determine stylization for the translated text string.

As just mentioned, in some embodiments, the style preservation system 102 utilizes a large language model to determine stylization for a translated text string, whereas the style preservation system 102 utilizes a neural machine translation model to generate the translated text string. For example, the style preservation system 102 processes the input text string 902 and the translated text string 906 through a large language model 910 to determine translated words to stylize. For example, the style preservation system 102 utilizes the large language model 910 to process the translated text string 906 to determine a translated word of the translated text string 906 corresponding to a stylized word of the input text string 902.

Moreover, in some implementations, the style preservation system 102 utilizes unigram mappings to determine the translated words to stylize. A unigram mapping includes an individual standalone unit of a text string. For instance, a unigram mapping includes a word of a sentence or a token representing an individual element of the sentence. In some embodiments, the style preservation system 102 generates a unigram mapping for each stylized word of the input text string 902. In the example shown in FIG. 9, the style preservation system 102 generates unigram mappings 908 for the words “nearly” and “fivefold,” which are stylized in the input text string 902 (with italics). The style preservation system 102 processes the unigram mappings 908 through the large language model 910 with the input text string 902 and the translated text string 906 to generate translated unigram mappings 912 of the translated words to be stylized.

In the example shown in FIG. 9, the style preservation system 102 utilizes the large language model 910 to generate unigram mappings for the translated words “fast” and “verfünffacht,” which correspond with the stylized input words “nearly” and “fivefold.” Thus, in some implementations, the style preservation system 102 determines the translated word(s) of the translated text string 906 for stylization based on the unigram mapping(s) of the stylized word(s) of the input text string 902. To illustrate, the style preservation system 102 generates the unigram mappings 908 by identifying the stylized words of the input text string 902 and processes the unigram mappings 908 through the large language model 910 to determine the translated unigram mappings 912 of the translated words.

Additionally, in some embodiments, the style preservation system 102 applies the style formatting element to the translated words of the translated text string. For example, the style preservation system 102 generates a stylized translated text string 914 by applying the style formatting element to the translated words of the translated text string 906 that correspond with the translated unigram mappings 912. In the example shown in FIG. 9, the stylized translated text string 914 reads “Auch der Stellenabbau hat sich in diesem Jahr im Vergleich zum Vorjahr fast verfünffacht,” where the translated words “fast” and “verfünffacht” are stylized with italics.

More particularly, in some embodiments, the style preservation system 102 generates a prompt for the large language model 910. For example, the style preservation system 102 generates a prompt that defines the unigram mappings. Additionally, the prompt instructs the large language model to provide translated unigram mappings of the relevant translated words (i.e., the translated words that correspond to the stylized input words). To illustrate, the prompt explains that the unigram mappings correspond to input words of the input text string 902 and that the large language model should provide translated unigram mappings of translated words that correspond to the input words with unigram mappings.

Furthermore, in some implementations, the style preservation system 102 processes the prompt, the input text string 902, and the translated text string 906 through the large language model 910 to generate the translated unigram mappings 912 of the translated words. Thus, utilizing the large language model 910, the style preservation system 102 identifies the corresponding translated words for stylization.

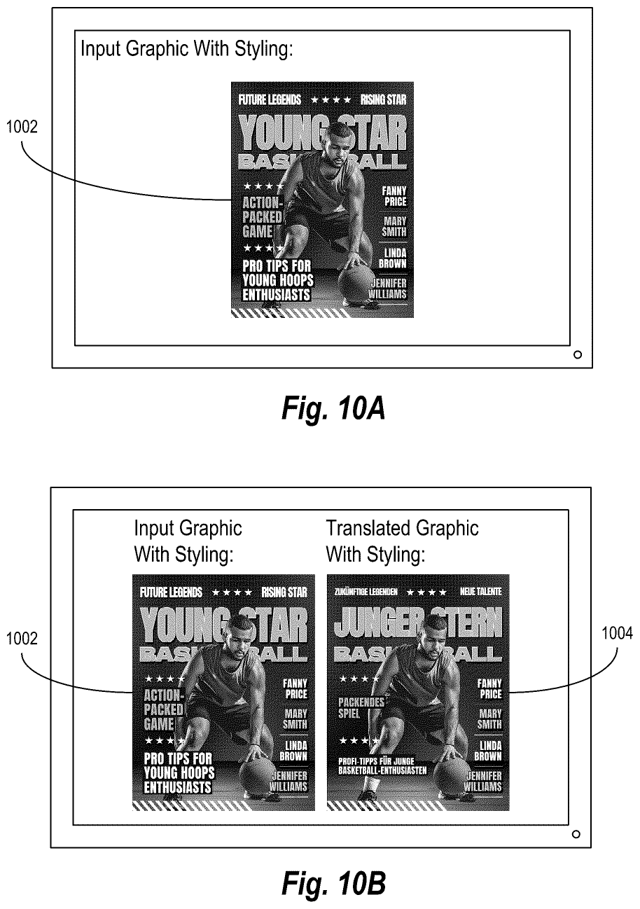

As discussed, in some embodiments, the style preservation system 102 provides a stylized translated text string for display. Moreover, in some embodiments, the style preservation system 102 provides a graphic with stylized translated text for display. For instance, FIGS. 10A-10B illustrate the style preservation system 102 providing an input graphic with stylized text and a translated graphic with stylized translated text for display via a graphical user interface in accordance with one or more embodiments.

Specifically, FIG. 10A shows a computing device (e.g., client device 108) with a graphical user interface. In some implementations, style preservation system 102 provides, for display via the graphical user interface, an input graphic 1002 comprising a style formatting element on text. In the example shown, the input graphic 1002 contains text that reads “YOUNG STAR,” among other text. Moreover, the text has a style formatting element of a particular font style, shape, color, and capitalization, among other style formats.

In some embodiments, the style preservation system 102 processes the input graphic 1002 through a translation and style preservation model to generate a translated graphic 1004 with stylized translated text. For example, FIG. 10B shows the style preservation system 102 providing the translated graphic 1004 for display via the graphical user interface. In the example shown, the translated graphic 1004 contains text that reads “JUNGER STERN,” among other translated text. As shown, the translated text has a style formatting element that matches the source text of the input graphic 1002 (“YOUNG STAR”). For instance, the font style, shape, color, and capitalization of the translated text in the translated graphic 1004 match those style formats of the source text of the input graphic 1002.

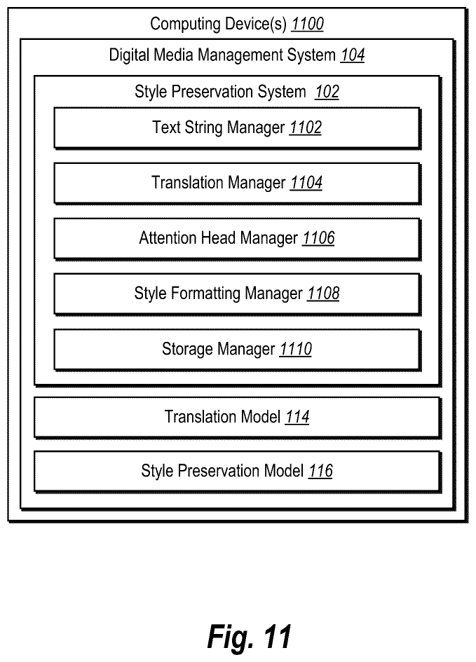

Turning now to FIG. 11, additional detail will be provided regarding components and capabilities of one or more embodiments of the style preservation system 102. In particular, FIG. 11 illustrates an example style preservation system 102 executed by a computing device(s) 1100 (e.g., the server device(s) 106 or the client device 108). As shown by the embodiment of FIG. 11, the computing device(s) 1100 includes or hosts the digital media management system 104 and/or the style preservation system 102. Furthermore, as shown in FIG. 11, the style preservation system 102 includes a text string manager 1102, a translation manager 1104, an attention head manager 1106, a style formatting manager 1108, and a storage manager 1110.

As shown in FIG. 11, the style preservation system 102 includes a text string manager 1102. In some implementations, the text string manager 1102 obtains an input text string comprising a style formatting element. Moreover, in some implementations, the text string manager 1102 extracts the style formatting element from the input text string. In some implementations, the text string manager 1102 generates a modified input text string comprising coded tags or delimiters for use with a neural network.

In addition, as shown in FIG. 11, the style preservation system 102 includes a translation manager 1104. In some implementations, the translation manager 1104 generates a translated text string from the input text string in a language different from that of the input text string. Moreover, in some embodiments, the translation manager 1104 utilizes a neural network, such as a transformer neural network, a neural machine translation model, or a large language model to generate the translated text string.

Moreover, as shown in FIG. 11, the style preservation system 102 includes an attention head manager 1106. In some implementations, the attention head manager 1106 determines attention head values generated by a transformer neural network for words of the input text string. Moreover, in some implementations, the attention head manager 1106 generates an attention head matrix from the attention head values. For example, in some embodiments, the attention head manager 1106 maps relationships between words of the input text string and translated words of the translated text string.

Furthermore, as shown in FIG. 11, the style preservation system 102 includes a style formatting manager 1108. In some implementations, the style formatting manager 1108 extracts a style formatting element from an input text string. In some embodiments, the style formatting manager 1108 generates a translated style formatting element for a translated text string. Moreover, in some implementations, the style formatting manager 1108 generates a stylized translated text string by applying a style of a stylized input word to a translated word corresponding to the stylized input word. In some embodiments, the style formatting manager 1108 applies the style formatting element to a translated word of the translated text string based on a coded tag, a delimiter, or a unigram mapping that identifies stylized words of the input text string.

Additionally, as shown in FIG. 11, the style preservation system 102 includes a storage manager 1110. In some implementations, the storage manager 1110 stores information (e.g., via one or more memory devices) on behalf of the style preservation system 102. For example, the storage manager 1110 includes an input text string, a style formatting element, a modified input text string, a translated text string, a stylized translated text string, a coded tag, a delimiter, and/or a unigram mapping. In some implementations, the storage manager 1110 includes parameters of one or more neural networks, such as a transformer neural network, a neural machine translation model, and/or a large language model.

Each of the components 1102-1110 of the style preservation system 102 includes software, hardware, or both. For example, the components 1102-1110 include one or more instructions stored on a computer-readable storage medium and executable by processors of one or more computing devices, such as a client device or server device. When executed by the one or more processors, in some implementations, the computer-executable instructions of the style preservation system 102 cause the computing device(s) to perform the methods described herein. Alternatively, in one or more implementations, the components 1102-1110 include hardware, such as a special purpose processing device to perform a certain function or group of functions. Alternatively, in some implementations, the components 1102-1110 of the style preservation system 102 include a combination of computer-executable instructions and hardware.

Furthermore, the components 1102-1110 of the style preservation system 102 are, for example, implemented as one or more operating systems, as one or more stand-alone applications, as one or more modules of an application, as one or more plug-ins, as one or more library functions, as one or more functions callable by other applications, and/or as a cloud-computing model. Thus, in some implementations, the components 1102-1110 are implemented as a stand-alone application, such as a desktop or mobile application. Furthermore, in various implementations, the components 1102-1110 are implemented as one or more web-based applications hosted on a remote server. In some implementations, the components 1102-1110 are implemented in a suite of mobile device applications or “apps.” To illustrate, in some implementations, the components 1102-1110 are implemented in an application, including but not limited to Adobe Acrobat, Adobe Creative Cloud, Adobe Express, Adobe Fresco, Adobe Illustrator, Adobe InCopy, Adobe InDesign, and Adobe Photoshop. The foregoing are either registered trademarks or trademarks of Adobe in the United States and/or other countries.

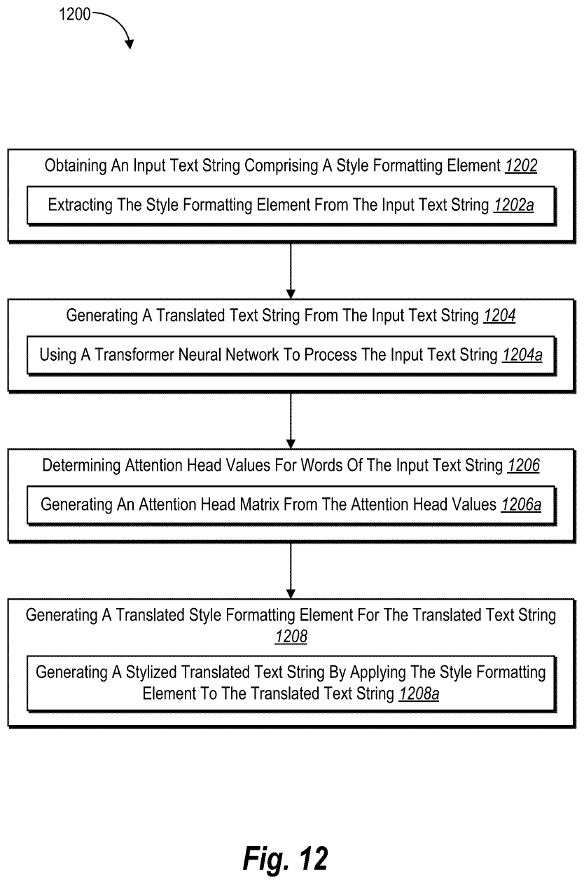

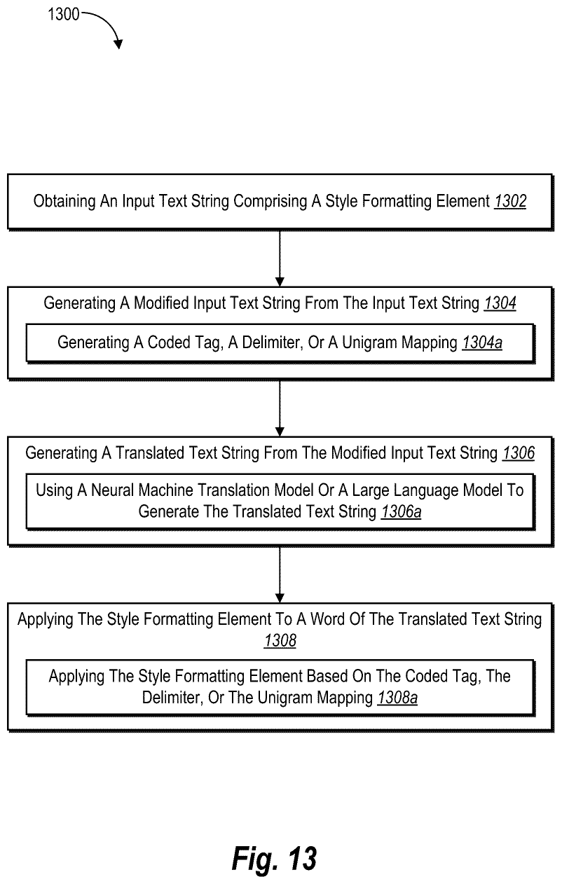

FIGS. 1-11, the corresponding text, and the examples provide a number of different methods, systems, devices, and non-transitory computer-readable media of the style preservation system 102. In addition to the foregoing, one or more embodiments are described in terms of flowcharts comprising acts for accomplishing a particular result, as shown in FIGS. 12 and 13. In some implementations, the processes of the style preservation system 102 are performed with more or fewer acts. Furthermore, in various implementations, the acts are performed in differing orders. Additionally, in some implementations, the acts described herein are repeated or performed in parallel with one another or in parallel with different instances of the same or similar acts.

As mentioned, FIG. 12 illustrates a flowchart of a series of acts 1200 for preserving styles of translated text using attention head values in accordance with one or more implementations. While FIG. 12 illustrates acts according to one implementation, alternative implementations omit, add to, reorder, and/or modify any of the acts shown in FIG. 12. In one or more implementations, the acts of FIG. 12 are performed as part of a method (e.g., a computer-implemented method). Alternatively, in one or more implementations, a non-transitory computer-readable storage medium comprises instructions that, when executed by one or more processors, cause a computing device to perform the acts of FIG. 12. In some implementations, a system performs the acts of FIG. 12.

As shown in FIG. 12, the series of acts 1200 includes an act 1202 of obtaining an input text string comprising a style formatting element, an act 1204 of generating a translated text string from the input text string, an act 1206 of determining attention head values for words of the input text string, and an act 1208 of generating a translated style formatting element for the translated text string. Additionally, as shown in FIG. 12, the series of acts 1200 includes an act 1202a of extracting the style formatting element from the input text string, an act 1204a of using a transformer neural network to process the input text string, an act 1206a of generating an attention head matrix from the attention head values, and an act 1208a of generating a stylized translated text string by applying the style formatting element to the translated text string.

In particular, in some implementations, the act 1202 includes obtaining an input text string in a first language, the input text string comprising a style formatting element, the act 1204 includes generating, using a transformer neural network to process the input text string, a translated text string in a second language different from the first language, the act 1206 includes determining attention head values generated by the transformer neural network for words of the input text string as part of generating the translated text string in the second language, and the act 1208 includes generating a translated style formatting element for the translated text string based on the attention head values for the words of the input text string.

For example, in some implementations, the series of acts 1200 includes determining the attention head values for the words of the input text string by generating an attention head matrix comprising a mapping of relationships between the words of the input text string and translated words of the translated text string. Moreover, in some implementations, the series of acts 1200 includes generating the attention head matrix by comparing encoder states for the input text string to predict the relationships between the words of the input text string and the translated words of the translated text string.

Furthermore, in some implementations, the series of acts 1200 includes generating the translated style formatting element for the translated text string by: utilizing the attention head values to map a word of the translated text string with a stylized word of the input text string stylized by the style formatting element; and applying the style formatting element to the word of the translated text string. Additionally, in some implementations, the series of acts 1200 includes generating the translated style formatting element for the translated text string by: comparing a first attention head value for a word of the input text string relative to a first word of the translated text string and a second attention head value for the word of the input text string relative to a second word of the translated text string; and applying the style formatting element to the first word of the translated text string based on comparing the first attention head value and the second attention head value.

Moreover, in some implementations, the series of acts 1200 includes generating the translated style formatting element for the translated text string by: generating a byte pair encoding for a stylized word of the input text string; determining an embedding distance between the byte pair encoding for the stylized word and a translated byte pair encoding of a translated word of the translated text string; and applying a style of the stylized word to the translated word of the translated text string based on the embedding distance. Furthermore, in some implementations, the series of acts 1200 includes providing, for display via a user interface of a client device, the translated text string in the second language with the translated style formatting element applied to a word of the translated text string according to the attention head values. Moreover, in some implementations, the series of acts 1200 includes generating the translated text string in the second language by: utilizing an encoder to determine an intermediate representation for a word of the input text string; and comparing the intermediate representation for the word with another intermediate representation for another word of the input text string.

In addition, in some implementations, the series of acts 1200 includes extracting, using a style extractor, a style formatting element from an input text string in a first language; generating, using a transformer neural network to process the input text string, a translated text string in a second language different from the first language; generating, from attention head values of the transformer neural network, an attention head matrix for words of the input text string by mapping relationships between the words of the input text string and translated words of the translated text string; and generating a stylized translated text string by applying the style formatting element to the translated text string according to the attention head matrix.

For example, in some implementations, the series of acts 1200 includes extracting the style formatting element from the input text string by using the style extractor to determine a stylized word of the input text string; and generating the stylized translated text string by using a style applier to add a style of the stylized word to a translated word of the translated text string. Moreover, in some implementations, the series of acts 1200 includes generating the stylized translated text string by: utilizing the attention head values to map a word of the translated text string with a stylized word of the input text string stylized by the style formatting element; and using a style applier to add a style of the stylized word to a translated word of the translated text string.

Furthermore, in some implementations, the series of acts 1200 includes generating the stylized translated text string by: comparing a first attention head value for a stylized word of the input text string relative to a first word of the translated text string and a second attention head value for the stylized word of the input text string relative to a second word of the translated text string; and using a style applier to add a style of the stylized word to the first word of the translated text string based on comparing the first attention head value and the second attention head value. Additionally, in some implementations, the series of acts 1200 includes generating the stylized translated text string by: generating a byte pair encoding for a stylized word of the input text string; determining an embedding distance between the byte pair encoding for the stylized word and a translated byte pair encoding of a translated word of the translated text string; and using a style applier to add a style of the stylized word to the translated word of the translated text string based on the embedding distance. Furthermore, in some implementations, the series of acts 1200 includes generating the translated word by removing the byte pair encoding from the translated byte pair encoding.

In addition, in some implementations, the series of acts 1200 includes extracting, using a style extractor, a style formatting element from an input text string in a first language; generating, using a transformer neural network to process the input text string, a translated text string in a second language different from the first language; determining attention head values generated by the transformer neural network for words of the input text string as part of generating the translated text string in the second language; and generating a stylized translated text string by using a style applier on the translated text string to apply the style formatting element to translated words indicated by the attention head values of the transformer neural network.

For example, in some implementations, the series of acts 1200 includes generating the stylized translated text string by mapping a word of the input text string to a plurality of translated words of the translated text string based on corresponding attention head values exceeding a threshold attention head value. Moreover, in some implementations, the series of acts 1200 includes generating the stylized translated text string by mapping a plurality of words of the input text string to a translated word of the translated text string based on corresponding attention head values exceeding a threshold attention head value.

Furthermore, in some implementations, the series of acts 1200 includes extracting the style formatting element from the input text string by using the style extractor to determine a stylized word of the input text string. Additionally, in some implementations, the series of acts 1200 includes generating the stylized translated text string by using the style applier to add a style of the stylized word to a translated word of the translated text string. Moreover, in some implementations, the series of acts 1200 includes determining the attention head values for the words of the input text string by generating an attention head matrix by comparing encoder states for the input text string to predict relationships between the words of the input text string and translated words of the translated text string.

As mentioned, FIG. 13 illustrates a flowchart of a series of acts 1300 for preserving styles of translated text using neural networks in accordance with one or more implementations. While FIG. 13 illustrates acts according to one implementation, alternative implementations omit, add to, reorder, and/or modify any of the acts shown in FIG. 13. In one or more implementations, the acts of FIG. 13 are performed as part of a method (e.g., a computer-implemented method). Alternatively, in one or more implementations, a non-transitory computer-readable storage medium comprises instructions that, when executed by one or more processors, cause a computing device to perform the acts of FIG. 13. In some implementations, a system performs the acts of FIG. 13.

As shown in FIG. 13, the series of acts 1300 includes an act 1302 of obtaining an input text string comprising a style formatting element, an act 1304 of generating a modified input text string from the input text string, an act 1306 of generating a translated text string from the modified input text string, and an act 1308 of applying the style formatting element to a word of the translated text string. Additionally, as shown in FIG. 13, the series of acts 1300 includes an act 1304a of generating a coded tag, a delimiter, or a unigram mapping, an act 1306a of using a neural machine translation model or a large language model to generate the translated text string, and an act 1308a of applying the style formatting element based on the coded tag, the delimiter, or the unigram mapping.

In particular, in some implementations, the act 1302 includes obtaining an input text string, the input text string comprising a style formatting element, the act 1304 includes generating a modified input text string from the input text string, the modified input text string comprising a coded tag identifying the style formatting element, the act 1306 includes generating, utilizing a neural machine translation model, a translated text string from the modified input text string, and the act 1308 includes applying the style formatting element to a word of the translated text string based on the coded tag of the modified input text string.

For example, in some implementations, the series of acts 1300 includes generating the modified input text string by: generating the coded tag at a beginning of a text portion comprising the style formatting element; and generating an additional coded tag at an end of the text portion comprising the style formatting element. Moreover, in some implementations, the series of acts 1300 includes generating the translated text string by retaining the coded tag and the additional coded tag in the translated text string. Furthermore, in some implementations, the series of acts 1300 includes applying the style formatting element to the word of the translated text string by: removing the coded tag and the additional coded tag from the translated text string; and stylizing the translated text string by applying the style formatting element to a translated text portion corresponding to the text portion.

Additionally, in some implementations, the series of acts 1300 includes applying the style formatting element to the word of the translated text string by generating a graphic design element for the translated text string. Moreover, in some implementations, the series of acts 1300 includes providing, for display via a user interface of a client device, the translated text string with the style formatting element applied to the word of the translated text string as the graphic design element.

In addition, in some implementations, the series of acts 1300 includes obtaining an input text string, the input text string comprising a style formatting element; generating a modified input text string from the input text string, the modified input text string comprising a first delimiter identifying a beginning of the style formatting element and a second delimiter identifying an end of the style formatting element; generating, utilizing a large language model, a translated text string from the modified input text string, the translated text string comprising the first delimiter and the second delimiter; and applying the style formatting element to a word of the translated text string based on the first delimiter and the second delimiter.

For example, in some implementations, the series of acts 1300 includes generating a prompt that defines the first delimiter and the second delimiter and instructs the large language model to translate the input text string while retaining the first delimiter and the second delimiter in the translated text string. Moreover, in some implementations, the series of acts 1300 includes generating the translated text string by processing the prompt and the modified input text string through the large language model to generate the translated text string.

Furthermore, in some implementations, the series of acts 1300 includes generating the modified input text string by: generating the first delimiter at a beginning of a text portion comprising the style formatting element; and generating the second delimiter at an end of the text portion comprising the style formatting element. Additionally, in some implementations, the series of acts 1300 includes generating the translated text string by retaining the first delimiter and the second delimiter in the translated text string. Moreover, in some implementations, the series of acts 1300 includes applying the style formatting element to the word of the translated text string by: removing the first delimiter and the second delimiter from the translated text string; and stylizing the translated text string by applying the style formatting element to a translated text portion corresponding to a text portion of the input text string comprising the style formatting element.

Furthermore, in some implementations, the series of acts 1300 includes applying the style formatting element to the word of the translated text string by generating a graphic design element for the translated text string. Moreover, in some implementations, the series of acts 1300 includes providing, for display via a user interface of a client device, the translated text string with the style formatting element applied to the word of the translated text string as the graphic design element.

In addition, in some implementations, the series of acts 1300 includes obtaining an input text string, the input text string comprising a style formatting element; generating, utilizing a neural machine translation model, a translated text string from the input text string; determining, utilizing a large language model to process the translated text string, a translated word of the translated text string corresponding to a stylized word of the input text string based on a unigram mapping of the stylized word of the input text string; and applying the style formatting element to the translated word of the translated text string.

For example, in some implementations, the series of acts 1300 includes generating the unigram mapping by identifying the stylized word of the input text string. Moreover, in some implementations, the series of acts 1300 includes processing the unigram mapping through the large language model to determine a translated unigram mapping of the translated word.

Furthermore, in some implementations, the series of acts 1300 includes generating a prompt that defines the unigram mapping and instructs the large language model to provide a translated unigram mapping of the translated word. Additionally, in some implementations, the series of acts 1300 includes determining the translated word of the translated text string by processing the prompt, the input text string, and the translated text string through the large language model to generate the translated unigram mapping of the translated word.

Moreover, in some implementations, the series of acts 1300 includes applying the style formatting element to the translated word of the translated text string by generating a graphic design element for the translated text string. Furthermore, in some implementations, the series of acts 1300 includes providing, for display via a user interface of a client device, the translated text string with the style formatting element applied to the word of the translated text string as the graphic design element.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 14 illustrates a block diagram of an example computing device 1400 that may be configured to perform one or more of the processes described above. One will appreciate that one or more computing devices, such as the computing device 1400, may represent the computing devices described above (e.g., the computing device(s) 1100, the server device(s) 106, or the client device 108). In one or more embodiments, the computing device 1400 may be a mobile device (e.g., a mobile telephone, a smartphone, a PDA, a tablet, a laptop, a camera, a tracker, a watch, a wearable device, etc.). In some embodiments, the computing device 1400 may be a non-mobile device (e.g., a desktop computer or another type of client device). Further, the computing device 1400 may be a server device that includes cloud-based processing and storage capabilities.

As shown in FIG. 14, the computing device 1400 can include one or more processor(s) 1402, memory 1404, a storage device 1406, input/output interfaces 1408 (or “I/O interfaces 1408”), and a communication interface 1410, which may be communicatively coupled by way of a communication infrastructure (e.g., bus 1412). While the computing device 1400 is shown in FIG. 14, the components illustrated in FIG. 14 are not intended to be limiting. Additional or alternative components may be used in other embodiments. Furthermore, in certain embodiments, the computing device 1400 includes fewer components than those shown in FIG. 14. Components of the computing device 1400 shown in FIG. 14 will now be described in additional detail.

In particular embodiments, the processor(s) 1402 includes hardware for executing instructions, such as those making up a computer program. As an example, and not by way of limitation, to execute instructions, the processor(s) 1402 may retrieve (or fetch) the instructions from an internal register, an internal cache, memory 1404, or a storage device 1406 and decode and execute them.

The computing device 1400 includes the memory 1404, which is coupled to the processor(s) 1402. The memory 1404 may be used for storing data, metadata, and programs for execution by the processor(s). The memory 1404 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1404 may be internal or distributed memory.

The computing device 1400 includes the storage device 1406 for storing data or instructions. As an example, and not by way of limitation, the storage device 1406 can include a non-transitory storage medium described above. The storage device 1406 may include a hard disk drive (“HDD”), flash memory, a Universal Serial Bus (“USB”) drive or a combination these or other storage devices.

As shown, the computing device 1400 includes one or more I/O interfaces 1408, which are provided to allow a user to provide input to (such as user strokes), receive output from, and otherwise transfer data to and from the computing device 1400. These I/O interfaces 1408 may include a mouse, keypad or a keyboard, a touch screen, camera, optical scanner, network interface, modem, other known I/O devices or a combination of such I/O interfaces 1408. The touch screen may be activated with a stylus or a finger.

The I/O interfaces 1408 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1408 are configured to provide graphical data to a display for presentation to a user. The graphical data may be representative of one or more graphical user interfaces and/or any other graphical content as may serve a particular implementation.

The computing device 1400 can further include a communication interface 1410. The communication interface 1410 can include hardware, software, or both. The communication interface 1410 provides one or more interfaces for communication (such as, for example, packet-based communication) between the computing device and one or more other computing devices or one or more networks. As an example, and not by way of limitation, communication interface 1410 may include a network interface controller (“NIC”) or network adapter for communicating with an Ethernet or other wire-based network or a wireless NIC (“WNIC”) or wireless adapter for communicating with a wireless network, such as a WI-FI. The computing device 1400 can further include the bus 1412. The bus 1412 can include hardware, software, or both that connects components of computing device 1400 to each other.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
obtaining an input text string, the input text string comprising a style formatting element;
generating a modified input text string from the input text string, the modified input text string comprising a coded tag identifying the style formatting element;
generating, utilizing a neural machine translation model, a translated text string from the modified input text string; and
applying the style formatting element to a word of the translated text string based on the coded tag of the modified input text string.

2. The computer-implemented method of claim 1, wherein generating the modified input text string comprises:
generating the coded tag at a beginning of a text portion comprising the style formatting element; and
generating an additional coded tag at an end of the text portion comprising the style formatting element.

3. The computer-implemented method of claim 2, wherein generating the translated text string comprises retaining the coded tag and the additional coded tag in the translated text string.

4. The computer-implemented method of claim 3, wherein applying the style formatting element to the word of the translated text string comprises:
removing the coded tag and the additional coded tag from the translated text string; and
stylizing the translated text string by applying the style formatting element to a translated text portion corresponding to the text portion.

5. The computer-implemented method of claim 1, wherein applying the style formatting element to the word of the translated text string comprises generating a graphic design element for the translated text string.

6. The computer-implemented method of claim 5, further comprising providing, for display via a user interface of a client device, the translated text string with the style formatting element applied to the word of the translated text string as the graphic design element.

7. A system comprising:
a memory component; and
one or more processing devices coupled to the memory component, the one or more processing devices to perform operations comprising:
obtaining an input text string, the input text string comprising a style formatting element;
generating a modified input text string from the input text string, the modified input text string comprising a first delimiter identifying a beginning of the style formatting element and a second delimiter identifying an end of the style formatting element;
generating, utilizing a large language model, a translated text string from the modified input text string, the translated text string comprising the first delimiter and the second delimiter; and
applying the style formatting element to a word of the translated text string based on the first delimiter and the second delimiter.

8. The system of claim 7, wherein the operations further comprise generating a prompt that defines the first delimiter and the second delimiter and instructs the large language model to translate the input text string while retaining the first delimiter and the second delimiter in the translated text string.

9. The system of claim 8, wherein generating the translated text string comprises processing the prompt and the modified input text string through the large language model to generate the translated text string.

10. The system of claim 7, wherein generating the modified input text string comprises:
generating the first delimiter at a beginning of a text portion comprising the style formatting element; and
generating the second delimiter at an end of the text portion comprising the style formatting element.

11. The system of claim 7, wherein generating the translated text string comprises retaining the first delimiter and the second delimiter in the translated text string.

12. The system of claim 7, wherein applying the style formatting element to the word of the translated text string comprises:
removing the first delimiter and the second delimiter from the translated text string; and
stylizing the translated text string by applying the style formatting element to a translated text portion corresponding to a text portion of the input text string comprising the style formatting element.

13. The system of claim 7, wherein applying the style formatting element to the word of the translated text string comprises generating a graphic design element for the translated text string.

14. The system of claim 13, wherein the operations further comprise providing, for display via a user interface of a client device, the translated text string with the style formatting element applied to the word of the translated text string as the graphic design element.

15. A non-transitory computer-readable medium storing executable instructions that, when executed by a processing device, cause the processing device to perform operations comprising:
obtaining an input text string, the input text string comprising a style formatting element;
generating, utilizing a neural machine translation model, a translated text string from the input text string;
determining, utilizing a large language model to process the translated text string, a translated word of the translated text string corresponding to a stylized word of the input text string based on a unigram mapping of the stylized word of the input text string; and
applying the style formatting element to the translated word of the translated text string.

16. The non-transitory computer-readable medium of claim 15, wherein the operations further comprise:
generating the unigram mapping by identifying the stylized word of the input text string; and
processing the unigram mapping through the large language model to determine a translated unigram mapping of the translated word.

17. The non-transitory computer-readable medium of claim 15, wherein the operations further comprise generating a prompt that defines the unigram mapping and instructs the large language model to provide a translated unigram mapping of the translated word.

18. The non-transitory computer-readable medium of claim 17, wherein determining the translated word of the translated text string comprises processing the prompt, the input text string, and the translated text string through the large language model to generate the translated unigram mapping of the translated word.

19. The non-transitory computer-readable medium of claim 15, wherein applying the style formatting element to the translated word of the translated text string comprises generating a graphic design element for the translated text string.

20. The non-transitory computer-readable medium of claim 19, wherein the operations further comprise providing, for display via a user interface of a client device, the translated text string with the style formatting element applied to the translated word of the translated text string as the graphic design element.
